(19) United States
(12) Patent Application Publication
(10) Pub. No.: US 2012/0325074 A1
(43) Pub. Date: Dec. 27, 2012

(54) MUSIC MACHINE

(75) Inventor: ANDREI V. SMIRNOV, Wadsworth, OH (US)

(73) Assignee: Dr. Andrei V. Smirnov, Wadsworth, OH (US)

(21) Appl. No.: 13/168,959

(22) Filed: Jun. 25, 2011

(51) Int. Cl. G10H 1/06

(52) U.S. Cl. 84/622

(57) ABSTRACT

This application describes a method and an apparatus which enable one to compose music using hierarchical musical scales and harmonic sequences, where each harmonic sequence of a higher level is derived from the one on the lower level. Frequencies associated with harmonic sequence on each level above the first one are obtained as multiples of the corresponding frequencies on a lower level. The sets of multipliers used to scale the frequencies between the levels is restricted to respective groups of rational numbers, or scales, where each level in a harmonic hierarchy can be related to its own scale, or a single scale can be used for all levels. When composing for an orchestra of multiple instruments, harmonic sequences and scales can be assigned independently to each musical instrument.

### BACKGROUND

Music is produced by combination of sounds of different tones, or pitches, which can be characterized by fundamental physical frequencies of sound waves. Most conventional approaches to musical composition are based on providing a time sequence of such tones, which have their frequencies in a certain relation to each-other, that makes it pleasant to ear. In particular, the relations characterized by simple ratios, such as 2, 1/2, 3/2, 3/4, 4/3, etc. are most pleasant. This could be related to resonances caused by such frequencies inside the ear, or some more complex phenomena inside the brain.

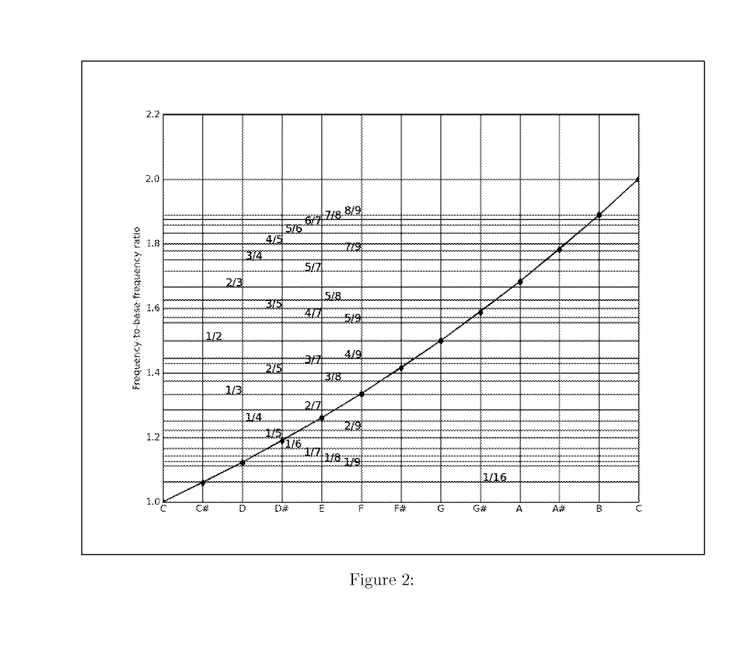

Indeed, the earlier instruments were based on resonating strings, and were tuned to follow these ratios, which is reflected, for example, in Pythagorean scale. However, those scales have a limitation that it is impossible to build a set of octaves from those scales, spanning several orders of magnitude of the base frequency. This is the reason why, most modern instruments are based on chromatic scale, which removes this limitation by sub-dividing an arbitrary range of frequencies into equal intervals on a logarithmic scale (FIG. 2, where number above each line added to one is equal to the scaling factor used to obtain the frequency associated with that line). But by moving to a logarithmic scale, one can no longer reproduce exact ratios for most of the tones. Thus, chromatic scale is a compromise between the purity of tones and versatility of the instrument, i.e. piano or music keyboard.

Another method of musical composition is based on the idea of harmony, whereby a composition is subdivided into measures, and each measure being assigned to a specific harmony, which is defined as a sequence of harmonic triads or keys, that are pleasant to the ear. For example, the C, Am, F, G sequence of keys is common in many popular songs. Along with harmonic sequences, another common practice is to apply a frequency shift in a form of modulation, or transposition. In the current invention these ideas are generalized to a method of hierarchical multi-scale composition, which provides a procedure and an instrument, that can overcome the limitations of both Pythagorean and chromatic scales by unifying harmonic sequencing and transposition as a general method of hierarchical composition. This invention also generalizes the idea of a musical scale to a multi-scale composition, or multi-scale orchestra of instruments.

### DESCRIPTION

The system of generating musical sounds is proposed where the fundamental frequency of each sound is obtained as a multiple of another frequency, which in turn can be obtained as a multiple of yet another frequency, and so on. The multipliers can be selected from a subset of rational numbers, defined by simple ratios of two integers.

In the simplest case, which we shall refer to as level-0 composition, the procedure of creating a composition starts with a single base frequency (10) and a set of rational numbers. This set of rational numbers will be further referred to as the instrument scale (16), and each number in the set will be referred to as an instrument key. Each sound in a composition is characterized by its fundamental frequency, further referred to as a note frequency, and a corresponding time interval, which together will be referred to simply as a note (18). Usually, there are other parameters comprising a note, such as a volume, but those are of no consequence for the current method, and are implicitly presumed to be given if needed. The procedure introduced here sets for each time interval in a composition a corresponding note frequency equal to a product of the base frequency and one of the keys from the instrument scale. This key selection can be done independently for each sound. The time intervals can be overlapping, thus allowing for playing chords.

Next extension of this procedure, which we shall call level-I composition, is to introduce another layer of frequencies and associated time intervals, further referred to as harmonic tones (14). In this case the intervals should be non-overlapping. The set of all harmonic tones in a composition will be referred to as the harmonic sequence (20). Each harmonic tone is determined in a similar manner as the note frequencies described above. Namely, a subset of rational numbers is introduced, further referred to as the harmonic scale (12), with each number in the subset called the harmonic key. Then the procedure is to set each harmonic tone equal to a product of the base frequency and one of the harmonic keys, where the latter can be selected arbitrarily from the harmonic scale. Now, in contrast to the level-0 composition, in this case the note frequencies are determined as products of harmonic tones and instrument keys. In particular, each note frequency will be obtained as a product of one harmonic tone and one of the instrument keys, where the harmonic tone is selected such that the start-time of the note interval lies within the time interval of the harmonic tone, and the instrument key can be arbitrarily selected from the instrument scale. The selection of a harmonic tone for each note is always possible and unique, because the time intervals of harmonic tones are restricted to be non-overlapping and to span the hole time of the composition, with a possible exception of pause intervals.

The level-1 composition procedure described above is essentially a generalization of what is known to musicians as transposition. One can generalize the above procedure further to level-N composition through an N-step frequency transformation which is specified for each time, t, in the composition, as:

fₙ₊₁(t)=fₙ(t)*kₙ(t)

where the initial frequency, f₀, or the base frequency will be a time-constant: f₀(t)=const, and keys, kₙ(t) at time, t, and each level n are selected from the corresponding n-level scale, Sₙ, as:

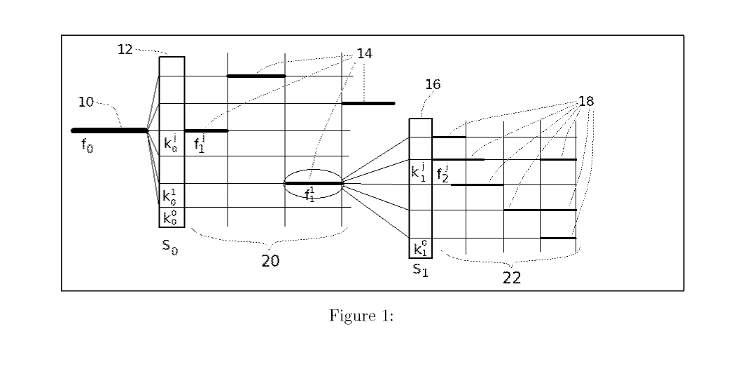

kₙ(t)= [symbol] ₙ^{(t)}(Sₙ) (1)

where [symbol] ₙ^{(t)} denotes a generally time-dependent selection operator provided by a composer or an algorithm. This procedure is illustrated in FIG. 1 for the case of level-2 composition, where fᵢ^{j} represent j-th frequency on i-th level, and kᵢ^{j} represent j-th key in i-th scale, Sᵢ. The above requirement of non-overlapping time intervals in a harmonic sequence means with regard to Eq. 1 that only the highest level selection operator, [symbol] ₘₐₓ₍ₙ₎^{(t)}, is allowed to generate multiple selections for the same value of t.

As it follows from the above, this method of composing music generates frequencies that are exact ratios of the base frequencies. This is in contrast to a conventional chromatic scale, in which the frequencies deviate from exact ratios of the base frequency with only few exceptions as illustrated in FIG. 2. From the perspective of physical reality of resonances and wave harmonics, frequencies produced as pure ratios of the fundamental frequency are more natural, and therefore tend to be more pleasant to human ear, which is indeed confirmed by the traditional rules of harmony.

As mentioned in the background section, the limitation of Pythagorean scale is in its inability to reproduce the same sequence of tones in different octaves. In the proposed method this limitation is overcome by introducing a generalized transposition as a system of multiple scales, and harmonic sequences. In this new framework it is now possible to shift, or transpose, the base frequency to any value, and do so independently for different instruments, and thereby play the same sequence of tones in different octaves, or indeed in any new frequency range, and still retain a simple rational scaling of the base frequency. It should be noted that such transposition can not be easily accomplished on traditional instruments, and thus, the proposed method is mostly adaptable to electronic instruments, computers, and other sound-capable digital devices.

The key principles outlined above are represented in the following Claims of this invention. Since a level-3 composition procedure will be most practical, these claims do not go beyond that level. In particular, the first independent Claim 1 describes a procedure of generating a sequence of sounds from a number of predetermined frequencies, called harmonic tones, which are uniquely assigned for each time interval of the composition, forming a harmonic sequence. This harmonic sequence can be seen as a pre-determined sequence of transpositions assigned to pre-determined time-intervals in the composition. The harmonic sequence determines a sequence of tones from which each the sequence of notes is obtained, producing an instrument score (22). For each harmonic tone a sequence of note frequencies can be generated by a simple scaling, where the scaling factors are rational numbers, that is, each such number is determined by a quotient of two integers. The set of these rational numbers can be fixed, in which case it is called the instrument scale (Claim 2). The process of selecting these scaling factors, or multipliers, is not essential as far as this invention is concerned, and is left to the composer or a computer algorithm. These claims essentially extend the idea of Pythagorean-like scales with the concept of generalized transposition based on multiple musical scales. The means for generating sounds named in Claim 1 can be represented by a suitable electric instrument or a digital computer supplied with an adequate audio system.

Claim 3 describes the level-2 composition as outlined above, where the harmonic tones are selected from a pre-defined subset of numbers, where each number is obtained as a multiple of a base frequency and a multiplier selected from a predetermined subset of rational numbers, called the harmonic scale.

Claims 4,5,6 extend the procedure to level-3 composition by introducing another set of frequencies, which define a harmonic sequence on a different level. This new frequencies can be selected from the same harmonic scale as in Claim 6, or a new scale can be introduced for that composition level as in Claim 5. The harmonic sequence on the higher level is derived from the one on the lower level by the same scaling procedure as described above. The harmonic scales on different levels can be setup independently from each other, however it would seem most practical to use just one harmonic scale on all levels.

The claims described so far dealt with a process of composing for a single instrument. Claims 7,8 extend this procedure to an orchestra composed of different instruments, each identified by its distinct timbre and capable of following its own harmonic sequence (Claim 7), or use its own instrument scale (Claim 8). This goes beyond a conventional orchestra, where each instrument, even though following an individual score, is restricted to play in the common scale, following a common harmonic sequence, and obeying a common transposition, if any. It can be noted that introducing such individual scales and/or harmonic sequences can simplify instrument scores, which can be of a special advantage in algorithmic compositions. It should also be noted that the meaning of harmonic sequence as defined here is different from the classical concept (see Sec.1).

The next set of claims describe a corresponding musical instrument, and orchestra that implement the procedure of multi-scale composition described above. In particular, the independent Claim 9 describes a sound capable device that can also set a frequency of each sound based on two sets of numbers: a harmonic tone, uniquely assigned to each time interval of the composition, and an arbitrary selected multiplier to produce each sound frequency when multiplied with the harmonic tone. The first means used to assign a set of harmonic tones can be implemented as a digital memory device controlled through a specialized input panel of a graphical user interface (GUI). The second means to set the frequency of each sound from the harmonic tone assigned above, can be implemented as a button, or a key on a musical instrument, or likewise a button in a software GUI implementation.

In Claim 10 the possible note frequencies are restricted to a specific set of frequencies, produced from the harmonic tones by scaling the latter with rational multipliers. That set of multipliers is referred to as instrument scale. In Claim 11 a similar restriction is applied to the set of harmonic tones themselves by introducing the harmonic scale. It should be noted that in different implementations the instrument and/or harmonic scales can be defined as a set of frequencies instead of rational numbers, or a set of pairs of integers forming a quotient. For example, an instrument scale can be given as a set of dimensional frequencies in Hz, all produced as multiples of a base frequency. In this case the note frequencies will be determined by the appropriate normalization of that set of frequencies and subsequent scaling. The net result will still be the same as using a rational set of numbers as an instrument scale. The same will relate to the harmonic scale. In practice the most convenient representation of instrument and harmonic scales would be to use a pair of integers for the numerator and the denominator of the respective fractions defining the scale keys.

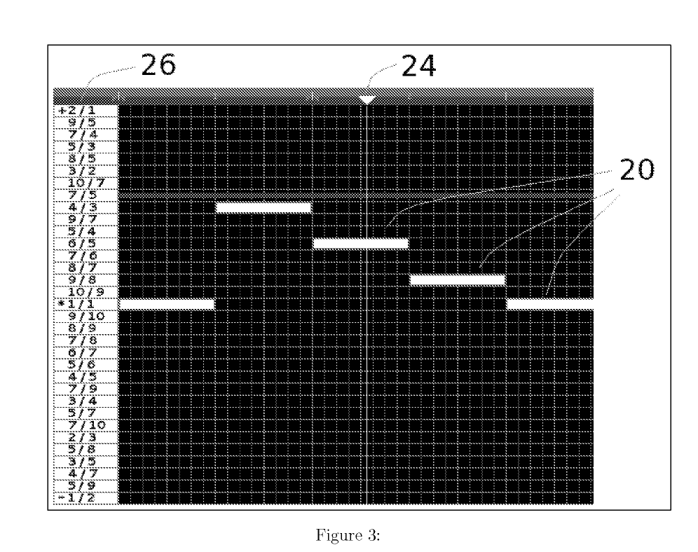

Claim 12 describes a music instrument or a computer software, which can memorize the harmonic sequence and keep it in memory for the time of the composition. This will be similar to keeping in device memory the harmonic sequence of the song, however, in this case the harmonic sequence is replaced by the concept of generalized transposition in form of harmonic tones, produced by scaling of the lower level frequency, as opposed to harmonic chords in the chromatic scale. The third means to enter the harmonic sequence into the device memory can be implemented in a similar manner as a typical piano-roll editor in modern MIDI-sequencer programs such as shown in FIG. 3.

Claims 13,14 extend the capabilities of the device to level-3 compositions, where three levels of frequency transpositions become possible.

Claims 16,17,15 extend the concept of multi-scale composition devices described above to an orchestra, which is a device capable of playing sounds of different timbre. In this case each distinct timbre relates to a different instrument. In particular, in an orchestra of Claim 16 each instrument of the orchestra is allowed to have its own base tone, or base frequency selected as a multiple of the global base frequency, which is the reference frequency of the orchestra, such as, 440 Hz usually assigned to note A in Chromatic scale.

In Claim 17, the above idea of different base frequencies is extended to allow different harmonic sequences for different instruments. The set of all harmonic sequences is called the composition harmony, and each instrument can follow its own harmonic sequence selected from the composition harmony.

In Claim 15 instead of a single instrument scale there is a number of such scales, called collectively the orchestra scale, and each instrument can use its individual instrument scale to produce note frequencies. The fourth means to enter the composition harmony in Claim 17 and the third means to enter the orchestra scale in Claim 15 can be implemented as adequate controller devices or a software GUI. Likewise fourth means in the Claim 15 and fifth means in Claim 17 can be implemented in a suitably designed GUI panel, extending the basic panel shown in FIG. 3.

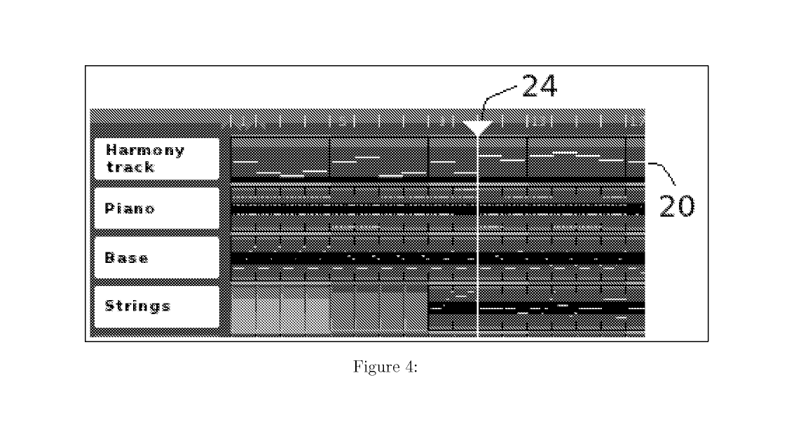

The possibility of displaying the progress of the performance within the harmonic sequence is described in Claim 18, where fourth means could be implemented as a liquid-crystal display embedded into a musical instrument, or a GUI-based panel shown in FIG. 3 and in FIG. 4 where the harmonic sequence (20) is shown as “Harmony track” in a prototype GUI panel, with the current position indicator (24).

It is important to have means of displaying the fractions from which the various scales are built. Claims 19,20 describe the possibility of displaying the scale keys as a numerator and denominator integers comprising the fractions of which the scales are defined. The third means can be implemented as a vertical bar in a piano-roll editor GUI-panel (26), replacing a piano keyboard with appropriate integer labels as shown in a snapshot of an experimental software prototype in FIG. 3.

### DRAWINGS

1. Assigning frequencies through multiple scales

2. Frequencies of chromatic scale

3. Instrument scale keys in a GUI piano-roll

4. Harmonic sequence shown as “Harmony track” in a GUI

### DESIGN ELEMENTS

10. Base frequency
12. Harmonic scale
14. Harmonic tones
16. Instrument scale
18. Notes
20. Harmonic sequence
22. Instrument score
24. Position indicator
26. Scale keys indicator panel

1. A method for playing a musical composition comprising the steps of:
(a) specifying a harmonic sequence as a sequence of harmonic tones, where each harmonic tone is a frequency assigned to a time interval within the composition, and said time intervals such that all intervals are non-overlapping and span the whole composition, that is, the start of the first time interval is equal to the start time of the composition, the end of the last time interval coincides with the end time of the composition, and the end of each time interval except the last one coincides with the start of the subsequent time interval,
(b) specifying instrument score as a sequence of notes, where each note includes a note frequency, and associated time interval, and where each note frequency is a multiple of one harmonic tone selected from said harmonic sequence, such that the start of the time interval of said note frequency lies inside the time interval of said harmonic tone,
(c) providing means for generating sounds at fundamental frequencies and at time intervals given by said instrument score,
whereby said method can allow one to play music composed of sounds as given by said instrument score.

2. The method of claim 1 wherein the multipliers used to set said note frequencies are selected from the instrument scale, which is a predetermined subset of rational numbers.

3. The method of claim 2 wherein the values of said harmonic tones are selected as multiples of a base frequency, which is a number selected from the range of audible frequencies, and the multipliers to set said harmonic tones as multiples of said base frequency are selected from the harmonic scale, which is a predetermined subset of rational numbers.

4. The method of claim 3 wherein said base frequency can be set to different values at different times in the composition.

5. The method of claim 4 wherein the values of said base frequency are selected as multiples of a predetermined number selected from the range of audible frequencies, and the multipliers to set said base frequency are selected from a predetermined subset of rational numbers.

6. The method of claim 5 wherein said predetermined subset of rational numbers to set said base frequency is equal to said harmonic scale.

7. The method of claim 3 further comprising the steps of:
(a) defining composition harmony, which is a set of said harmonic sequences,
(b) associating each sound of a certain timbre with its own harmonic sequence selected from said composition harmony,
whereby one can play musical composition composed of several instruments, each characterized by a different timbre, and each following its own harmonic sequence.

8. The method of claim 3 further comprising the steps of:
(a) defining orchestra scale, which is a set of different instrument scales,
(b) associating each sound of a certain timbre with its own instrument scale selected from said orchestra scale,
whereby one can play musical composition composed of several instruments, each characterized by a different timbre, and each using its own instrument scale.

9. An apparatus for playing a musical composition comprising:
(a) a device for generating sounds at specified fundamental frequencies and at specified time intervals,
(b) first means to associate a harmonic tone, which is an arbitrary number, with any time interval of the composition,
(c) second means to set the frequency of sound generated by said apparatus within any time interval of the composition as a multiple of said harmonic tone associated with that time interval.

10. The apparatus of claim 9 wherein the multiplier used to set the frequency of each sound from said harmonic tone is selected from an instrument scale, which is a predetermined subset of rational numbers, and said apparatus is supplied with the memory to store said instrument scale for the entire time of the composition.

11. The apparatus of claim 10 wherein said harmonic tones are selected as multiples of a base frequency, which is a number selected from the range of audible frequencies, and the multipliers for each time interval are selected from a harmonic scale, which is a predetermined subset of rational numbers, and said apparatus is supplied with the memory to store said harmonic scale for the entire time of the composition.

12. The apparatus of claim 11 further including:
(a) memory to store a harmonic sequence which is a predetermined set of said harmonic tones,
(b) third means to input said harmonic sequence into said memory.

13. The apparatus of claim 12 wherein said base frequency can be changed during the composition.

14. The apparatus of claim 13 wherein the changes of said base frequency are restricted to the multiples of a main frequency which is a predetermined number selected from the range of audible frequencies, and the multipliers are selected from a subset of rational numbers.

15. The apparatus of claim 10 wherein said device for generating sounds is also capable of producing sounds of different timbre and said apparatus further including:
(a) additional memory to store an orchestra scale, which is a predetermined set of different sets of said instrument scales,
(b) third means to input said orchestra scale into said additional memory,
(c) fourth means to associate each sound of certain timbre with one instrument scale selected from said orchestra scale,
whereby one can play music composed of sounds produced by different instruments, and each instrument using its own instrument scale.

16. The apparatus of claim 13 wherein said device for generating sounds is also capable of producing sounds of different timbre and where said base frequency can be selected differently for the sounds of different timbre.

17. The apparatus of claim 13 wherein said device for generating sounds is also capable of producing sounds of different timbre and said apparatus further including:
(a) additional memory to store a composition harmony which is a predetermined set of said harmonic sequences,
(b) fourth means to input said composition harmony into said additional memory,
(c) fifth means to associate each sound of certain timbre with one harmonic sequence selected from said composition harmony,
whereby one can play music composed of sounds produced by different instruments, and each instrument following its own harmonic sequence.

18. The apparatus of claim 12 further including fourth means to display any part of said harmonic sequence including the whole sequence as well as to indicate current time position within said harmonic sequence when playing a composition.

19. The apparatus of claim 10 further including third means to display said instrument scale, where each rational number in said instrument scale is indicated by two integer numbers, corresponding to the numerator and denominator of the quotient, defining this rational number.

20. The apparatus of claim 11 further including third means to display said harmonic scale, where each rational number in said harmonic scale is indicated by two integer numbers, corresponding to the numerator and denominator of the quotient, defining this rational number.
